(19) United States
(12) Patent Application Publication
(10) Pub. No.: US 2020/0228617 A1
(43) Pub. Date: Jul. 16, 2020

(54) EVENT RECORDING METHOD AND APPARATUS, ELECTRONIC DEVICE, AND STORAGE MEDIUM

(71) Applicant: BEIJING DAJIA INTERNET INFORMATION TECHNOLOGY CO., LTD., Beijing (CN)

(72) Inventor: Shaoze GUO, Beijing (CN)

(21) Appl. No.: 16/830,897

(22) Filed: Mar. 26, 2020

(30) Foreign Application Priority Data
Mar. 26, 2019 (CN) 201910232450.6

(51) Int. Cl. H04L 29/08

(52) U.S. Cl. CPC H04L 67/2809; H04L 67/26

(57) ABSTRACT

The present application relates to an event recording method and apparatus, an electronic device, and a storage medium. The event recording method includes: creating an event record set aiming at a target event; and associating the event record set with an author user recording the target event, wherein the event record set includes multimedia contents which are uploaded by the associated author user and aiming at the target event.

### CROSS-REFERENCE TO RELATED APPLICATION

This application claims priority of Chinese Patent Application No. 201910232450.6, filed on Mar. 26, 2019, which is hereby incorporated by reference in its entirety.

### FIELD

The present disclosure relates to the technical field of We-media, and particularly relates to an event recording method and apparatus, an electronic device, and a storage medium.

### BACKGROUND

In recent years, the mobile Internet technology has been booming, and users can photograph, modify, and upload multimedia contents including videos, pictures, and audios to the Internet by holding mobile terminals such as smartphones. This has greatly promoted the development and progress of the We-media industry.

Nowadays, using We-media to record life has become a fashion, and watching We-media contents of interest has also become a habit of many people in their leisure time. On a We-media platform, the users can view their favorite multimedia contents. In the related art, after a user finds a multimedia content of interest, if the user wants to continue to watch multimedia contents subsequently posted by a publisher of the found multimedia content and related to the multimedia content, the user generally needs to follow the aforementioned publisher. In this way, after the publisher posts new multimedia contents, since the aforementioned user has followed the publisher, the We-media platform will push the new multimedia contents to the user.

### SUMMARY

According to a first aspect of the embodiment of the present disclosure, an event recording method is provided, including:

creating an event record set for a target event; and

associating the event record set with an author user recording the target event, wherein the event record set includes multimedia contents which are uploaded by the associated author user and aiming at the target event.

Optionally, the method further includes:

receiving the multimedia contents which are uploaded by the author user and aiming at the target event; and

adding the received multimedia contents into the event record set.

Optionally, the method further includes:

receiving follow requests sent by a reader user and configured to ask for following the event record set; and

after the reader user follows the event record set, pushing the multimedia contents in the event record set to the reader user.

Optionally, the method further includes:

monitoring whether the event record set includes a newly added content or not, wherein the newly added content is a non-pushed multimedia content uploaded by a target author user to the event record set; and

if YES, pushing the newly added content to the following reader users following the event record set.

Optionally, the pushing the newly added content to the following reader users following the event record set includes:

when the newly added content has a browsing permission, determining a reader user defined by the browsing permission from the following reader users as a first user to be pushed, wherein the browsing permission is configured to define the reader user to browse the newly added content from the following reader users; and

pushing the newly added content to the first user to be pushed.

Optionally, after monitoring that the event record set includes the newly added event, the method further includes:

determining a concern extent of each non-following reader user to the target event from non-following reader users not following the event record set;

determining a reader user having the concern extent satisfying a preset condition as a second user to be pushed from the non-following reader users; and

pushing the newly added content to the second user to be pushed.

Optionally, the monitoring whether the event record set includes the newly added content or not includes:

when monitoring that the target author user uploads the newly added content, determining whether the newly added content is a multimedia content recording the target event or not;

if YES, adding the newly added content into the event record set, and determining that the event record set is monitored to include the newly added content; and

if NO, determining that the event record set is not monitored to include the newly added content.

According to a second aspect of the embodiment of the present disclosure, an electronic device is provided, including:

a processor; and

a memory, configured to store an executable instruction of the processor.

the processor is configured to: execute the instruction stored in the memory to perform any one of aforementioned event recording methods.

Optionally, the processor is further configured to: execute the instruction stored in the memory to perform following process of:

receiving multimedia contents uploaded for the target event by the author user; and adding received multimedia contents into the event record set.

Optionally, the processor is further configured to: execute the instruction stored in the memory to perform following process of:

receiving a follow request for asking for following the event record set sent by a reader user; and

after the reader user follows the event record set, pushing the multimedia contents in the event record set to the reader user.

Optionally, the processor is further configured to: execute the instruction stored in the memory to perform following process of:

monitoring whether the event record set comprises a newly added content or not, wherein the newly added content is a non-pushed multimedia content uploaded by a target author user to the event record set; and

if YES, pushing the newly added content to following reader users following the event record set.

Optionally, the processor is configured to execute the instruction stored in the memory to perform following process of pushing the newly added content to the following reader users following the event record set, by:

when the newly added content has a browsing permission, determining a reader user defined by the browsing permission from the following reader users as a first user to be pushed, wherein the browsing permission is configured to define a reader user to browse the newly added content from the following reader users; and

pushing the newly added content to the first user to be pushed.

Optionally, the processor is configured to execute the instruction stored in the memory to perform following process of:

after monitoring that the event record set comprises the newly added content,

determining a concern extent of each non-following reader user to the target event from non-following reader users not following the event record set;

determining a reader user having the concern extent satisfying a preset condition as a second user to be pushed from the non-following reader users; and

pushing the newly added content to the second user to be pushed.

Optionally the processor is configured to execute the instruction stored in the memory to perform following process of the monitoring whether the event record set comprises the newly added content or not, by:

when monitoring that the target author user uploads the newly added content, determining whether the newly added content is a multimedia content recording the target event or not;

if YES, adding the newly added content into the event record set, and determining that the event record set is monitored to comprise the newly added content; and

if NO, determining that the event record set is not monitored to comprise the newly added content.

According to a third aspect of the embodiment of the present disclosure, a non-transitory computer readable storage medium is provided. An instruction in the storage medium is executed by a processor of a mobile terminal to enable the mobile terminal to execute any one of aforementioned event recording methods.

According to a fourth aspect of the embodiment of the disclosure, an application program/computer program product is provided. The application program/computer program product is operated on a computer to enable the computer to execute any one of the event recording method.

### BRIEF DESCRIPTION OF THE DRAWINGS

The drawings herein are incorporated in and constitute a part of the specification, illustrating embodiments consistent with the present disclosure, and explaining the principles of the present disclosure together with the specification.

FIG. 1 is a flow diagram of an event recording method illustrated according to an exemplary embodiment;

FIG. 2 is a flow diagram of an event record set illustrated according to an exemplary embodiment;

FIG. 3 is a flow diagram of an interface illustrated according to an exemplary embodiment;

FIG. 4 is a flow diagram of a content display list according to an exemplary embodiment;

FIG. 5 is a block diagram of event recording apparatus illustrated according to an exemplary embodiment; and

FIG. 6 is a block diagram of an electronic device illustrated according to an exemplary embodiment.

### DETAILED DESCRIPTION OF THE EMBODIMENTS

Exemplary embodiments will be described in detail herein, examples of which are illustrated in the accompanying drawings. When the following description refers to the accompanying drawings, the same numbers in different drawings represent the same or similar elements unless otherwise indicated. The implementations described in the following exemplary embodiments do not represent all implementations consistent with the present disclosure. Rather, they are merely examples of apparatus and methods consistent with some aspects of the present disclosure as detailed in the appended claims.

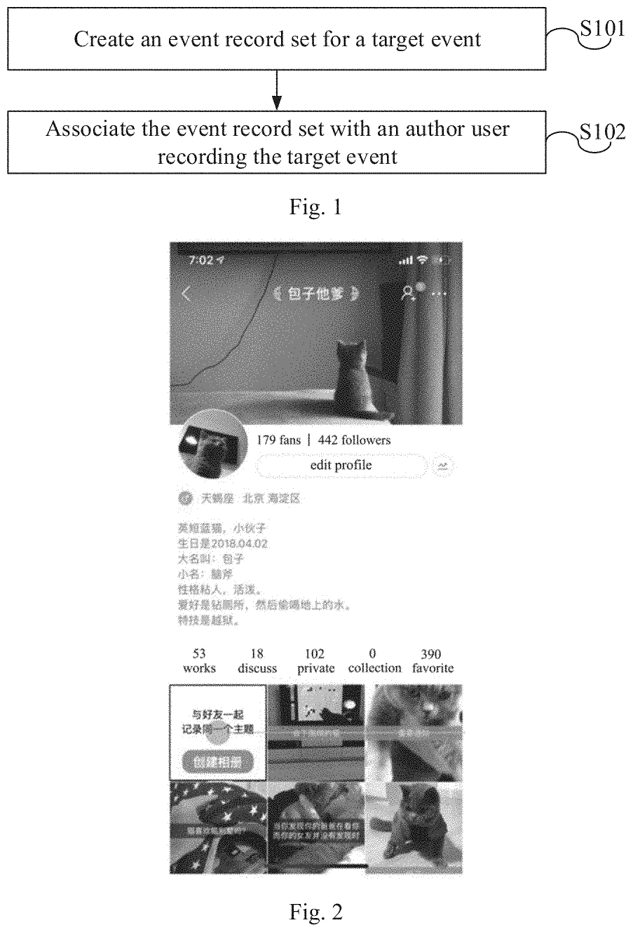

Some embodiments of the present disclosure provide an event recording method. The event recording method can be applied to a server. The server can be connected to a client to push related information to the client. FIG. 1 is a flow diagram of an event recording method illustrated according to an exemplary embodiment. As shown in FIG. 1, the event recording method includes the following steps.

S101, an event record set aiming at a target event is created.

The target event may be customized, may be a thing or an event that has happened, such as a sports meeting competition site, and may also be an item related to one or more objects, such as growing of a kitten named Huahua and a star named Li Si. The target event may also be an event aiming at one type. For example, the target event may aim at a type of things, such as a vocal concert and a motorcycle race, and may also be a related item aiming at a type of objects, such as a related event aiming at a student group.

The target event may be recorded through different multimedia contents such as characters, images, videos and cartoons. The target event may be recorded by only one kind of multimedia content, or may also be recorded in a manner of combining various multimedia contents, and it is not limited here.

The event record set may be customized in the form of a homepage, a group, an official account, an event box, and the like. The event record set is configured to record the target event. Based on this, the multimedia contents included in the event recording event all aim at the target event. In one implementation mode, it can be considered that the event record set is a container for storing the multimedia contents aiming at the target event. In another implementation mode, the event record set includes multimedia contents with specified identifiers. The specified identifiers correspond to the event record set. It can be considered that the multimedia contents uploaded to the server and having the specified identifiers are the multimedia contents recording the target event. These multimedia contents belong to the event record set, and may be displayed in the event record set.

In this way, by creating the event record set aiming at the target event, the problem of scattered distribution of the multimedia contents aiming at the target event may be avoided.

S102, the event record set is associated with author users recording the target event.

The author users may be considered as a participant and a witness of the target event, and other users who may describe the target event, and one target event may correspond to one or more author users.

The event record set may be associated with the author users, and the associated author users are users who may record the target event. The author users associated with the event record set may be customized, and the author users associated with the event record set may be added and deleted, that is, the number of associated author users may be increased and decreased.

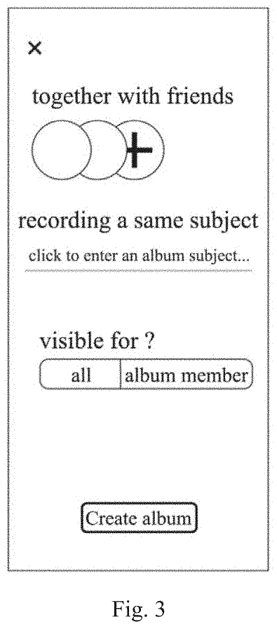

FIG. 3 is taken as an example. In an interface shown in FIG. 3, users may be added as the associated author users through “+” at the right bottom of “together with friends” in this interface. After the users are added and become the author users, the multimedia contents about the target event may be uploaded.

The author users associated with the event record set may upload the multimedia contents aiming at the target event to the event record set. In this way, the event record set includes the multimedia contents aiming at the target event and uploaded by the associated author users.

For example, the event record set is a homepage, as shown in FIG. 2, and the target event is the daily life of a kitten named Baozi. This homepage contains multimedia contents such as characters, images, and videos. These multimedia contents are all about the daily activities of the kitten, such as, kittens sleep, play, and eat. The author users associated with this homepage are the owner of the kitten: an author user A and an author user B. The author user A and the author user B record the daily activities of the kitten through the videos, the characters, the images, etc., and upload the multimedia contents, such as the videos, characters, and the images, of the daily activities of the kitten to the homepage. Therefore, the homepage may display the multimedia contents about the daily activities of the kitten.

In one implementation mode, the multimedia contents aiming at the target event and uploaded by the author users may be received, and the received multimedia contents are added into the event record set.

The multimedia contents capable of being added into the event record set are all the multimedia contents uploaded by the author users associated with the event record set, and are configured to record the target event. For example, the homepage as shown in FIG. 2 is the event record set. The author users associated with the homepage include the user A and the user B, so that the user A and the user B may upload the multimedia contents about the daily activities of the kitten to the homepage for displaying.

After the multimedia contents uploaded by the author users are received, whether the multimedia contents are about the target event or not may be detected. If they are about the target event, the multimedia contents may be added into the event record set. If they are not about the target event, the multimedia contents are not added into the event record set.

There may be two ways for adding the received the multimedia contents into the event record set. In the first way, the event record set is a container for storing the multimedia contents, and corresponds to a storage region. The multimedia contents in the storage region all belong to the event record set. In this case, the received multimedia contents may be stored into the storage region corresponding to the event record set, which may consider that the multimedia contents are added into the event record set.

In the second way, the multimedia contents included in the event record set all have specified identifiers. That is, the event record set corresponds to the specified identifiers, and the multimedia contents with the specified identifiers are the multimedia contents belonging to the event record set. The specified identifiers may be customized. In this case, the received multimedia content is marked by a specified identifier, and the marked multimedia content may be considered to be added into the event record set. The event record set may display the multimedia content.

Through the implementation mode, the author users may upload all the multimedia contents about the target event to the event record set. The event record set may intensively display the multimedia contents of the target event, thus displaying the target event more completely, and avoiding the problem of scattered distribution of the multimedia contents aiming at the target event.

In one implementation mode, follow requests which are sent by reader users and configured to ask for following the event record set by the users may be received. After the reader users follow the event record set, the multimedia contents in the event record set may be pushed to the reader users.

The event record set may be followed by the plurality of reader users, and may push the multimedia contents in the event record set to every following reader users. FIG. 2 is taken as an example. 179 fans shown in FIG. 2 represent that there are 179 reader users following this page, and this page may push the multimedia contents to the 179 reader users.

The pushed multimedia contents include historical multimedia contents, i.e., posted multimedia contents, and also include newly added multimedia contents.

Through the implementation mode, when the reader users follow a certain target event, the reader users may directly follow the event record set of the target event, and directly acquire related information of the target event from the event record set, so that the problem that the reader users need to follow many publishers to track subsequent development of the target event more completely is avoided.

In one implementation mode, whether the event record set includes a newly added content or not is monitored. If it is monitored that the event record set includes the newly added content, the newly added content is pushed to the following reader users following the event record set.

The newly added content is a non-pushed multimedia content uploaded by a target author user to the event record set. The target author user may be an author user associated with the event record set, or may also be an author user not associated with the event record set, and it is not limited here. It can be understood that the type of the newly added content is consistent with the types of the contents included in the event record set.

When the target author user is the author user associated with the event record set, the implementation mode of monitoring whether the event record set includes the newly added content or not may monitor whether the author users associated with the event record set upload multimedia contents or not. When it is monitored that there is an author user uploading a new multimedia content, it can be considered that the author user is the target author user. At this time, whether the multimedia content is about the target event or not may be detected. If the multimedia content is about the target event, it can be determined that the event record set includes the newly added content.

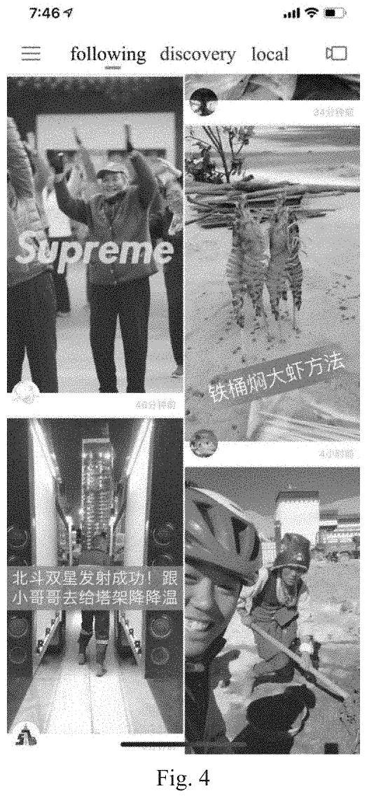

After the newly added content is pushed to the following reader users following the event record set, the following reader users may acquire the newly added content. In one implementation mode, after it is pushed to the reader users, the newly added content may appear in content display lists of the reader users. FIG. 4 shows the content display list of one of the reader users. The contents displayed in the content display list are all the contents followed by the reader user.

Through the implementation mode, when the event record set includes the newly added content about the target event, the event record set may be timely pushed to the reader users who have followed this target event. In this way, the timeliness that the reader users acquire the newly added content is guaranteed, and the user experience is enhanced.

In one implementation mode, in the above implementation mode, the step that the newly added content is pushed to the following reader users following the event record set may include the following steps.

When the newly added content has a browsing permission, a reader user defined by the browsing permission is determined from the following reader users as a first user to be pushed, and the newly added content is pushed to the first user to be pushed.

The browsing permission aims at the newly added content, and is configured to permit the reader user who can browse the newly added content in the following reader users. It can be considered that each multimedia content may have a browsing permission, and the browsing permission of each multimedia content may be customized. The browsing permissions corresponding to different multimedia contents may be the same or different.

For example, the multimedia content 1 has the browsing permission a, and the multimedia content 2 has the browsing permission b. The browsing permission a is only browsable to the reader user 1 and the reader user 2, and is non-browsable to other reader users. The browsing permission b is only non-browsable to the reader user 1 and the reader user 2, and is browsable to the other reader users.

The browsing permission may be set as enabling all users or users in certain ages to browse the content, and may also be set according to a user interaction relation of the author user uploading this newly added content. For example, the browsing permission is set as enabling users followed by the author users, reader users following the author users, users specified by the author users, and the like to browse the content. The browsing permission may also be set as all the author users associated with the event record set. In this case, the first user to be pushed determined by the browsing permission may be other author users except the author user uploading the newly added content. The browsing permission is not limited to the above several settings, and other browsing permissions may also be included. It is not limited here.

Through the implementation mode, the browsing permission may be set to the newly added content, so as to define the reader users capable of browsing the newly added content and then meet the requirement of the author user for a newly added content share range.

In one implementation mode, after it is monitored that the event record set includes the newly added content, the method may further include the following steps.

A concern extent of each non-following reader user to the target event is determined from the non-following reader users not following the event record set. In the non-following reader users, a reader user with the concern extent satisfying a preset condition is determined as a second user to be pushed, and the newly added content is pushed to the second user to be pushed.

The concern extent to the target event may be the number of multimedia contents with likes, the number of participating topics, durations of watching videos about the target event, and the like. It can be considered that for the multimedia contents of the target event, if there are more multimedia content with likes, the concern extent to the target event is higher; if there are more topics participating in the target event, the concern extent to the target event is higher; and if the duration of watching the videos about the target event is longer, the concern extent to the target event is higher.

The present condition may be customized. In the first implementation mode, the concern extent may be graded, and the preset condition may be at a customized preset grade, so that the reader users with the concern extents higher than or equal to the preset grade may be determined as the second users to be pushed. In the second implementation mode, the non-following reader users may be sequenced according to the concern extents, and a preset number of non-following reader users with the highest concern extent may be determined as the second users to be pushed according to the order. The preset number may be customized. In the third implementation mode, the second users to be pushed may be determined from the non-following reader users by using a content distribution algorithm. An input quantity of the content distribution algorithm may be customized, such as a subject and comments of the target event.

The preset condition may be further set by other implementation modes in addition to the above three implementation modes, and it is not limited here.

Through the implementation modes, the newly added content may also be pushed to non-following reader users who might be interested in the target event in addition to being pushed to the following reader users, so that multimedia contents in which the non-following reader users may be interested are provided for the non-following reader users, and the non-following reader users may also be attracted to follow the target event.

In one implementation mode, the step that whether the event record set includes the newly added content or not is monitored may include the following steps.

When it is monitored that the target author user uploads the newly added content, whether the newly added content is a multimedia content recording the target event or not is determined; if YES, the newly is added into the event record set, and it is determined that the event record set is monitored to include the newly added content; and if NO, it is determined that the event record set is not monitored to include the newly added content.

In one implementation mode, when the target author user is an author user associated with the event record set, the author user associated with the event record set may be monitored in real time. When it is monitored that the author user uploads the newly added content, whether the newly added content is the multimedia content recording the target event or not may be judged.

There may be at least three methods below for determining whether the newly added content is the multimedia content recording the target event or not.

In the first implementation mode, a title of the newly added content may be detected. If the title of the newly added content contains a character string of a specified title of the target event, it can be determined that the newly added content is the multimedia content recording the target event. For example, the character string of the specified title of the target event is: Kitten named Baozi. When the title contains “Kitten named Baozi”, it can be considered that the multimedia content corresponding to this title is the multimedia content recording the target event.

In the second implementation mode, when each multimedia content is uploaded, the uploaded multimedia content would carry a related identifier which is configured to determine which event does the multimedia content belong to. In this case, when it is monitored that the author user uploads the newly added content, an identifier of the newly added content may be acquired, and whether the newly added content is the multimedia content recording the target event or not is judged according to the identifier.

In the third implementation mode, the newly added content may be subjected to image identification, voice identification, and the like, thus determining whether the newly added content is the multimedia content recording the target event or not.

Through the implementation modes, the newly added content uploaded by the target author user may be detected to determine whether the newly added content is the multimedia content recording the target event or not, thereby timely and accurately monitoring whether the event record set includes the newly added content or not.

In the solution provided by the embodiment of the present disclosure, the event record set aiming at the target event is created, and the event record set is associated with the author users recording the target event. The event record set includes the multimedia contents uploaded by the associated author users and aiming at the target event. For the author users recording the same target event, the multimedia contents recording the target event can be uploaded to the event record set. In this way, the multimedia contents included in the event record set all aim at the target event. That is, the event record set may intensively track the multimedia contents of the target event, which avoids the problem of scattered distribution of the multimedia contents aiming at the target event. The reader users can track subsequent development of the target event by only following the event record set, which enhances the user experience.

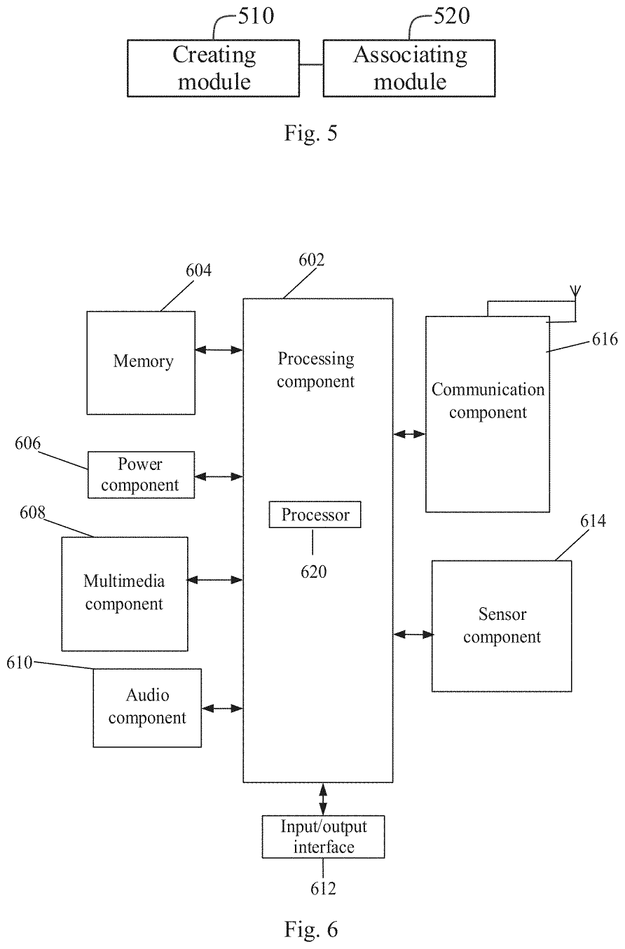

Corresponding to the embodiment of the above event recording method, the embodiment of the present disclosure further provides event recording apparatus. FIG. 5 is a block diagram of information pushing apparatus illustrated according to an exemplary embodiment. Referring to FIG. 5, the event recording apparatus includes: a creating module 510 and an associating module 520.

The creating module 510 is configured to create an event record set aiming at a target event.

The associating module 520 is configured to associate the event record set with author users recording the target event, wherein the event record set includes multimedia contents uploaded by the associated author users and aiming at the target event.

In one implementation mode, the event recording apparatus may further include:

a first receiving module, configured to receive the multimedia contents uploaded by the author users and aiming at the target event; and

an adding module, configured to add the received multimedia contents into the event record set.

In one implementation mode, the event recording apparatus may further include:

a second receiving module, configured to receive follow requests sent by reader users and configured to ask for following the event record set; and

a first pushing module, configured to push the multimedia contents in the event record set to the reader users after the reader users follow the event record set.

In one implementation mode, the event recording apparatus may further include:

a monitoring module, configured to monitor whether the event record set includes a newly added content or not, wherein the newly added content is a non-pushed multimedia content uploaded by a target author user to the event record set; and

a second pushing module, configured to push the newly added content to the following reader users following the event record set when the monitoring module monitors that the event record set includes the newly added content.

In one implementation mode, the second pushing module is specifically configured to:

when the newly added content has a browsing permission, determine a reader user defined by the browsing permission from the following reader users as a first user to be pushed, wherein the browsing permission is configured to define the reader user to browse the newly added content from the following reader users; and push the newly added content to the first user to be pushed.

In one implementation mode, the event recording apparatus may further include:

a first determining module, configured to determine a concern extent of each non-following reader user to the target event from non-following reader users not following the event record set;

a second determining module, configured to determine a reader user having the concern extent satisfying a preset condition from the non-following reader users as a second user to be pushed; and

a third pushing module, configured to push the newly added content to the second user to be pushed.

In one implementation mode, the monitoring module is specifically configured to:

when monitoring that the target author user uploads the newly added content, determine whether the newly added content is a multimedia content recording the target event or not;

if YES, add the newly added content into the event record set, and determine that the event record set is monitored to include the newly added content; and

if NO, determine that the event record set is not monitored to include the newly added content.

In the solution provided by the embodiment of the present disclosure, the event record set aiming at the target event is created, and the event record set is associated with the author users recording the target event. The event record set includes the multimedia contents uploaded by the associated author users and aiming at the target event. For the author users recording the same target event, the multimedia contents recording the target event can be uploaded to the event record set. In this way, the multimedia contents included in the event record set all aim at the target event. That is, the event record set may intensively track the multimedia contents of the target event, which avoids the problem of scattered distribution of the multimedia contents aiming at the target event. The reader users can track the subsequent development of the target event by only following the event record set, which enhances the user experience.

Corresponding to the embodiment of the above event recording method, FIG. 6 is a block diagram of an electronic device illustrated according to an exemplary embodiment. For example, the electronic device may be a video camera, a camera, a mobile phone, a computer, a digital broadcasting terminal, a message transmitting and receiving device, a game console, a tablet device, a medical device, a fitness device, a personal digital assistant, and the like.

Referring to FIG. 6, the electronic device may include one or more of the following components: a processing component 602, a memory 604, a power component 606, a multimedia component 608, an audio component 610, an input/output (I/O) interface 612, a sensor component 614, and a communication component 616.

The processing component 602 generally controls overall operations of the electronic device, such as operations related to displaying, telephone calls, data communications, camera operations, and recording operations. The processing component 602 may include one or more processors 620 to execute instructions so as to complete all or part of the steps of the method described above. In addition, the processing component 602 may include one or more modules to facilitate interaction between the processing component 602 and other components. For example, the processing component 602 may include a multimedia module to facilitate interaction between the multimedia component 608 and the processing component 602.

The memory 604 is configured to store various types of data to support the operations at the electronic device. Examples of such data include instructions for any application program or method operated on the electronic device, contact data, phone book data, messages, pictures, videos, and the like. The memory 604 may be implemented by any type of volatile or non-volatile storage devices or a combination thereof, such as static random access memory (SRAM), an electrically erasable programmable read-only memory (EEPROM), a programming read-only memory (EPROM), a programmable read-only memory (PROM), a read-only memory (ROM), a magnetic memory, a flash memory, a magnetic disk or an optical disk.

The power component 606 provides power to the various components of the electronic device. The power component 606 may include a power management system, one or more power supplies, and other components associated with generation, management, and power distribution for the electronic device.

The multimedia component 608 includes a screen that provides an output interface between the electronic device and a user. In some embodiments, the screen may include a liquid crystal display (LCD) and a touch panel (TP). If it includes a TP, the screen may be implemented as a touch screen to receive an input signal from the user. The TP includes one or more touch sensors to sense touch, swipe, and gestures on the TP. The touch sensor may not only sense a boundary of a touch or swipe action, but also detect duration and pressure related to the touch or swipe operation. In some embodiments, the multimedia component 608 includes a front camera and/or a rear camera. When the electronic device is in an operation mode, such as a photographing mode or a video mode, the front camera and/or the rear camera may receive external multimedia data. Each front camera and each rear camera may be fixed optical lens systems or may have focal lengths and optical zoom capabilities.

The audio component 610 is configured to output and/or input audio signals. For example, the audio component 610 includes a microphone (MIC), and the microphone is configured to receive an external audio signal when the electronic device is in operation modes, such as a calling mode, a recording mode, and a voice identification mode. The received audio signal may be further stored in the memory 604 or transmitted via the communication component 616. In some embodiments, the audio component 610 further includes a speaker for outputting the audio signals.

The I/O interface 612 provides an interface between the processing component 602 and a peripheral interface module. The peripheral interface module may be a keyboard, a click wheel, buttons, and the like. These buttons may include, but not limited to: a home button, a volume button, a start button, and a lock button.

The sensor component 614 includes one or more sensors for providing various aspects of state assessment for the electronic device. For example, the sensor component 614 may detect an on/off state of the electronic device and relative positioning of components. For example, the components are a display and a small keypad of the electronic device. The sensor component 614 may further detect a position change of the electronic device or one component of the electronic device, the presence or absence of user contact with the electronic device, orientation or acceleration/deceleration of the electronic device, and temperature variations of the electronic device. The sensor component 614 may include a proximity sensor configured to detect the presence of objects nearby without any physical contact. The sensor component 614 may also include a light sensor, such as a CMOS or CCD image sensor, for use in imaging applications. In some embodiments, the sensor component 614 may also include an acceleration sensor, a gyroscope sensor, a magnetic sensor, a pressure sensor, or a temperature sensor.

The communication component 616 is configured to facilitate wired or wireless communications between the electronic device and other devices. The electronic device may access a wireless network based on a communication standard, such as WiFi, an operator network (such as 2G, 3G, 4G, or 5G), or a combination of the wireless network and the operator network. In one exemplary embodiment, the communication component 616 receives a broadcast signal or broadcast related information from an external broadcast management system via a broadcast channel. In one exemplary embodiment, the communication component 616 further includes a near field communication (NFC) module to facilitate short-range communications.

In the exemplary embodiment, the electronic device may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above method.

In the exemplary embodiment, a non-transitory computer-readable storage medium including instructions, such as a memory 604 including the instructions, is further provided. The instructions may be executed by the processor 620 of the electronic device to complete the foregoing method. For example, the non-transitory computer-readable storage medium may be an ROM, an RAM, a CD-ROM, a magnetic tape, a floppy disk, an optical data storage device, and the like.

Corresponding to the embodiment of an aforementioned event recording method, some embodiments of the present disclosure further provide a non-transitory computer-readable storage medium. An instruction in the storage medium is executed by a processor of a mobile terminal to enable the mobile terminal to execute the steps of the event recording method.

Corresponding to the embodiment of the aforementioned event recording method, the embodiment of the present disclosure further provides a computer program product configured to execute the steps of the above event recording method.

Those skilled in the art will easily think of other implementation solutions of the present application after considering the specification and practicing the invention disclosed here. The present application is intended to cover any variations, uses, or adaptive changes of the present disclosure. These variations, uses, or adaptive changes follow the general principles of the present application and include common general knowledge or conventional technical means in the technical field, which are not disclosed in the present application. The specification and the embodiments are considered as being exemplary only, with a true scope and spirit of the present application being indicated by the following claims.

It should be understood that the present application is not limited to the precise structure that has been described above and shown in the drawings, and various modifications and changes can be made without departing from the scope thereof. The scope of the present application is limited only by the appended claims.

1. An event recording method, comprising:
creating an event record set for a target event; and
associating the event record set with an author user recording the target event, wherein the event record set comprises multimedia contents which are uploaded by associated author user and aiming at the target event.

2. The method according to claim 1, further comprising:
receiving multimedia contents uploaded which are updated by the author user and aiming at the target event; and
adding received multimedia contents into the event record set.

3. The method according to claim 1, further comprising:
receiving a follow request sent by a reader user and configured to ask for following the event record set; and
after the reader user follows the event record set, pushing the multimedia contents in the event record set to the reader user.

4. The method according to claim 1, further comprising:
monitoring whether the event record set comprises a newly added content or not, wherein the newly added content is a non-pushed multimedia content uploaded by a target author user to the event record set; and
if YES, pushing the newly added content to following reader users following the event record set.

5. The method according to claim 4, wherein the pushing the newly added content to the following reader users following the event record set comprises:
when the newly added content has a browsing permission, determining a reader user defined by the browsing permission from the following reader users as a first user to be pushed, wherein the browsing permission is configured to define a reader user to browse the newly added content from the following reader users; and
pushing the newly added content to the first user to be pushed.

6. The method according to claim 4, wherein after monitoring that the event record set comprises the newly added content, the method further comprises:
determining a concern extent of each non-following reader user to the target event from non-following reader users not following the event record set;
determining a reader user having the concern extent satisfying a preset condition as a second user to be pushed from the non-following reader users; and
pushing the newly added content to the second user to be pushed.

7. The method according to claim 4, wherein the monitoring whether the event record set comprises the newly added content or not comprises:
when monitoring that the target author user uploads the newly added content, determining whether the newly added content is a multimedia content recording the target event or not;
if YES, adding the newly added content into the event record set, and determining that the event record set is monitored to comprise the newly added content; and
if NO, determining that the event record set is not monitored to comprise the newly added content.

8. An information pushing electronic device, comprising:
a processor; and
a memory, configured to store an executable instruction of the processor,
wherein the processor is configured to: execute the instruction stored in the memory to perform the event recording method according to claim 1.

9. The information pushing electronic device according to claim 8, wherein the processor is further configured to: execute the instruction stored in the memory to perform following process of:
receiving multimedia contents uploaded for the target event by the author user; and
adding received multimedia contents into the event record set.

10. The information pushing electronic device according to claim 8, wherein the processor is further configured to: execute the instruction stored in the memory to perform following process of:
receiving a follow request for asking for following the event record set sent by a reader user; and
after the reader user follows the event record set, pushing the multimedia contents in the event record set to the reader user.

11. The information pushing electronic device according to claim 8, wherein the processor is further configured to: execute the instruction stored in the memory to perform following process of:
monitoring whether the event record set comprises a newly added content or not, wherein the newly added content is a non-pushed multimedia content uploaded by a target author user to the event record set; and
if YES, pushing the newly added content to following reader users following the event record set.

12. The information pushing electronic device according to claim 11, wherein the processor is configured to execute the instruction stored in the memory to perform following process of pushing the newly added content to the following reader users following the event record set, by:
when the newly added content has a browsing permission, determining a reader user defined by the browsing permission from the following reader users as a first user to be pushed, wherein the browsing permission is configured to define a reader user to browse the newly added content from the following reader users; and
pushing the newly added content to the first user to be pushed.

13. The information pushing electronic device according to claim 11, wherein the processor is configured to execute the instruction stored in the memory to perform following process of:
after monitoring that the event record set comprises the newly added content,
determining a concern extent of each non-following reader user to the target event from non-following reader users not following the event record set;
determining a reader user having the concern extent satisfying a preset condition as a second user to be pushed from the non-following reader users; and
pushing the newly added content to the second user to be pushed.

14. The information pushing electronic device according to claim 11, wherein the processor is configured to execute the instruction stored in the memory to perform following process of the monitoring whether the event record set comprises the newly added content or not, by:
when monitoring that the target author user uploads the newly added content, determining whether the newly added content is a multimedia content recording the target event or not;
if YES, adding the newly added content into the event record set, and determining that the event record set is monitored to comprise the newly added content; and
if NO, determining that the event record set is not monitored to comprise the newly added content.

15. A non-transitory computer readable storage medium, wherein an instruction in the storage medium is executed by a processor of a mobile terminal to enable the mobile terminal to execute the event recording method according to claim 1.

16. A computer program product, being operated on a computer to enable the computer to execute the event recording method according to claim 1.
